(19) United States
(12) Patent Application Publication
(10) Pub. No.: US 2024/0191696 A1
(43) Pub. Date: Jun. 13, 2024

(54) OFFSHORE WIND TURBINE SYSTEM AND OFFSHORE PLATFORM

(71) Applicant: STIESDAL OFFSHORE A/S, Give (DK)

(72) Inventor: Henrik Stiesdal, Odense (DK)

(21) Appl. No.: 18/286,246

(22) PCT Filed: Apr. 7, 2022
(86) PCT No.: PCT/DK2022/050074

§ 371 Date: Oct. 10, 2023

(30) Foreign Application Priority Data
Apr. 12, 2021 (DK) PA 2021 70170

(51) Int. Cl. F03D 13/25; B63B 35/44

(52) U.S. Cl. CPC F03D 13/256; B63B 35/44; B63B 2035/446; F05B 2240/93; F05B 2240/95

(57) ABSTRACT

An offshore platform with a wind turbine is provided including three buoyancy modules arranged in a triangular configuration in corners of an equilateral triangle, in the center of which the tower support for the tower of the wind turbine is located. The tower support is fixed in a frame including three radial braces, each of the radial braces rigidly connecting the tower support with one of the three buoyancy modules. The radial braces are inclined upwards from the tower support towards the buoyancy modules.

### CROSS-REFERENCE TO RELATED APPLICATIONS

This application claims priority to PCT Application No. PCT/DK2022/050074, having a filing date of Apr. 7, 2022, which claims priority to DK Application No. PA 2021 70170, having a filing date of Apr. 12, 2021, the entire contents both of which are hereby incorporated by reference.

### FIELD OF TECHNOLOGY

The following relates to a floating offshore platform and its combination with a wind turbine. The following also relates to a wind turbine and offshore structure.

### BACKGROUND

For floating platforms for offshore wind turbines, triangular shapes are often desired due to their high degree of stiffness relatively to size and, thus, also with respect of the relatively small amount of necessary material, which still is substantial for large wind turbines. Examples are given in international patent application WO2017/157399. In order to give the platform stability in stormy conditions, submerged weights have been proposed. However, this principle is rather costly.

US 2016/0362861 A1 discloses an offshore wind turbine system comprising a wind turbine having a tower, and a floating platform comprising a tower support. The platform comprises an equilateral triangular frame wherein the tower support is arranged in the center thereof. At each of the three edges of the triangle, there is provided a buoyancy module. Three radial braces connect the tower support with each of the three buoyancy modules. The radial braces are inclined upwards from the tower support at an angle of 45-90°.

US2015/0329180 A1 discloses a floating body structure of the type described in the preamble of the independent claims. According to this document the floating body structure is sunk and floated in the water at a predetermined water depth to reduce the influence of the sea waves. Accordingly, this floating structure will under normal use not be arranged in the water surface partly under water level and partly over the water level. Accordingly, the floating structure will not be influenced by the waves in such way that a momentum originating from the sea waves can contribute to stabilizing the floating offshore structure.

It would be desirable to find simpler ways for stabilizing offshore platforms in windy conditions.

### SUMMARY

An aspect relates to an improved configuration for floating offshore platforms for wind turbines, especially provide simple means for improving stability in windy conditions.

The offshore platform carries the wind turbine in water in offshore conditions. The wind turbine comprises a tower and a rotor, typically mounted on a nacelle.

In short, the offshore platform comprises three buoyancy modules arranged in a triangular configuration in corners of an equilateral triangle, in the center of which the tower support for the tower of the wind turbine is located. The tower support is fixed in a frame comprising three radial braces, each of which is rigidly connecting the tower support with one of the three buoyancy modules. The radial braces are inclined upwards from the tower support, typically from the bottom part of the tower support, towards the buoyancy modules.

The term “buoyancy module” is used for an element that provides buoyancy and/or stability to the platform. For example, the buoyancy module is a buoyancy tank or comprises a plurality of buoyancy tanks fitted together. In some embodiments, a buoyancy module comprises or is a vertical or near-vertical cylinder, a group of two or more vertical or near-vertical cylinders, or other configuration of relevant vertical or near-vertical vessels that are located at the corners of the triangular configuration and can provide buoyancy and/or stability to the platform.

In more detail, the offshore platform comprises a tower support, for example tower support column, which carries the tower of the wind turbine. The platform comprises three buoyancy modules. For example, each buoyancy module comprises a group of buoyancy members, for example a group of two, three or more buoyancy members, such as buoyancy tanks. The buoyancy modules are lighter than water and provide buoyancy to the platform when in water. The three modules are arranged in a triangular configuration in corners of an equilateral triangle in which the tower support is located in the center. In more detail, the tower support comprises a centerline coinciding with a centerline of the tower when mounted on the platform and being located in the center of the triangle.

The platform comprises a frame of rigid tubular members, in particular braces, that are connecting the buoyancy modules with the tower support. A convenient and useful configuration is a tetrahedral configuration.

Accordingly, the tower support is fixed in a frame comprising three radial braces, each of the radial braces rigidly connecting the tower support with one of the three buoyancy modules. The three radial braces are connected to a bottom part of the tower support structure.

Each radial brace has a brace centerline, the brace centerline having an angle α (alpha) with the tower support centerline. In particular, this angle α is in the range of 80° to 87°. It needs to be mentioned that the radial braces are inclined upwards from the tower support towards the buoyancy modules in order to be submerged in water when in use.

The value of the angle α in the range of 80-87° is implying that an angle β=(90°−α) is in the range of 3-10°, which would be the angle between the radial brace with the water surface in steady calm water under non-windy conditions. In general, it can be said that the smaller α and the larger β, the more counter-momentum towards a vertical orientation of the tower is given. However, on the other hand, increased inclination of the radial braces, equivalent to a smaller angle α, also results in increased draft, which can be critical when mounting the wind turbine on the platform in a harbor, where often only a draft of 8 m can be accepted. The given angular range is a compromise between increased stability and practical draft.

For example, the platform with the buoyancy modules and the frame when in water is dimensioned for reaching downwards into water to a depth of no more than 8 m when carrying a wind turbine having a weight of 2,000,000 kg (2000 tons).

In order to achieve sufficient buoyancy, the system in water is dimensioned for floating at a level in the water where at least 80% or at least 90% of the radial braces are under water for contributing to the buoyancy.

The buoyancy modules have a height H. In embodiments, the radial braces are connected to the buoyancy modules at a connection point positioned at a level between 0.3 and 0.7 of H, for example between 0.4 and 0.6, of H. When the connection point is at the water surface level, this implies that a substantial part of the buoyancy modules extends downwards into the water from the connection point with the radial braces. Water movement, typically from waves, exerting forces on this downward extending portion of the buoyancy modules creates a counter-momentum to the momentum from the wind turbine due to wind. This counter-momentum has a stabilizing effect on the overall offshore system in windy condition with waves.

In embodiments, the frame comprises three lateral braces, each of which interconnect neighboring radial braces for additional stabilization. In particular, the three lateral braces are arranged in a plane perpendicular to the tower support centerline, the latter coinciding with the centerline of the tower.

For example, the frame comprises three diagonal braces, each of which extends from the support column to a corresponding one of the three radial braces. These are not in a planar configuration. The three diagonal braces are connected to a top part of the tower support structure.

This arrangement of braces may in total form a tetrahedral shape.

### BRIEF DESCRIPTION

Some of the embodiments will be described in detail, with references to the following Figures, wherein like designations denote like members, wherein:

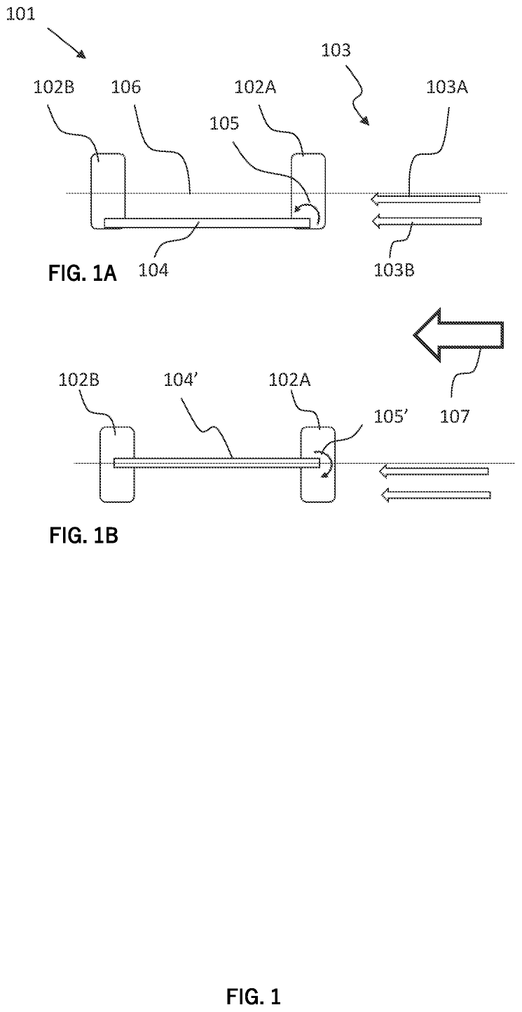

FIG. 1A illustrates the buoyancy modules are connected at their bottoms by a rigid frame:

FIG. 1B illustrates the buoyancy modules are connected at midpoints by a rigid frame:

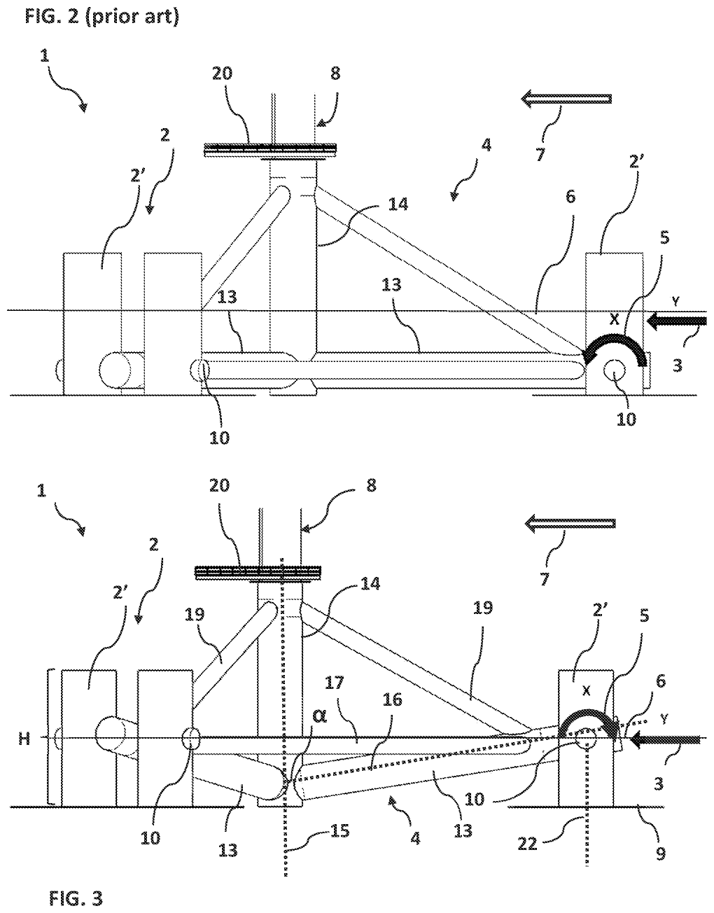

FIG. 2 illustrates a floating platform according to conventional art:

FIG. 3 illustrates a floating platform according to embodiments of the invention;

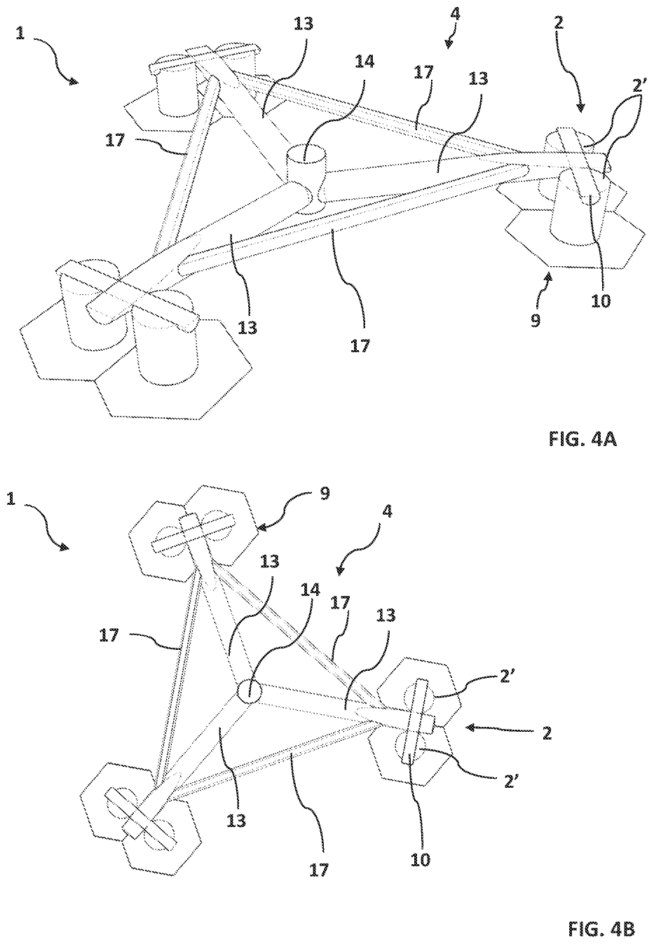

FIG. 4A illustrates an underwater part of the floating platform from a perspective view;

FIG. 4B illustrates an underwater part of the floating platform from a top view:

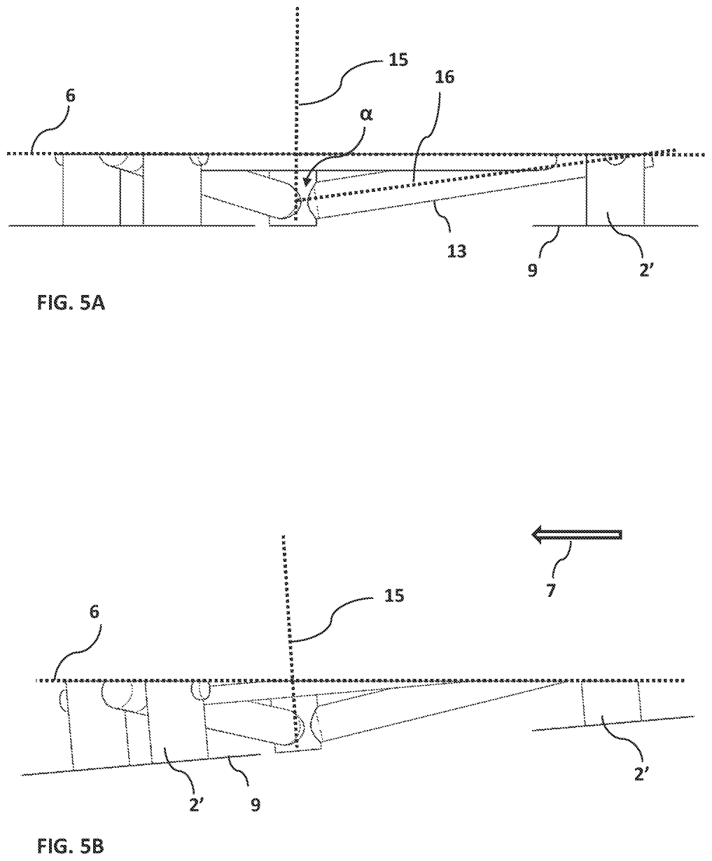

FIG. 5A illustrates the underwater part of the platform with the centerline of the tower vertical:

FIG. 5B illustrates the underwater part of the platform with the centerline of the tower inclined:

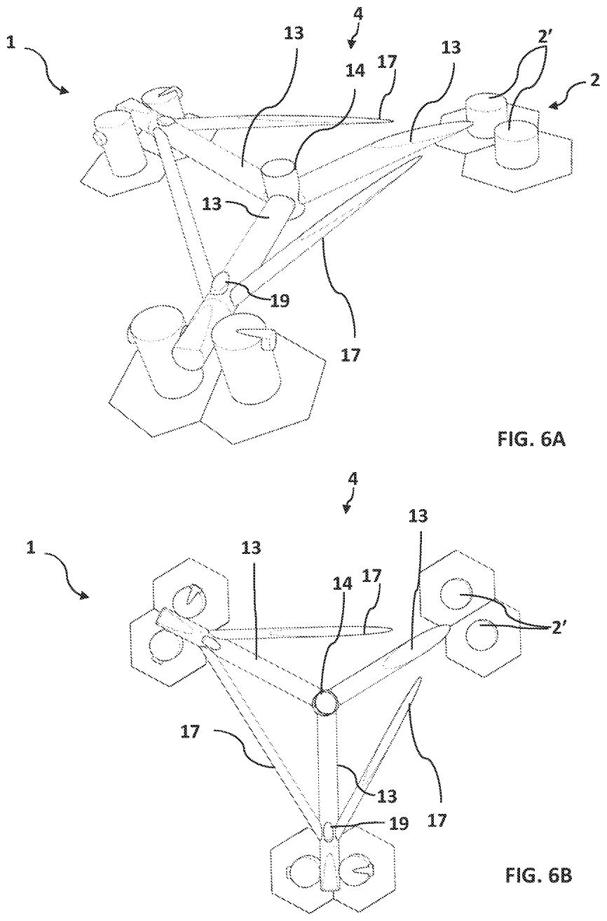

FIG. 6A illustrates the inclined underwater part in a perspective view; and FIG. 6B illustrates the inclined underwater part in a top view.

### DETAILED DESCRIPTION

FIGS. 1A and 1B illustrate a basic principle of embodiments of the invention for ease of understanding. The illustrated floating offshore platform 101 comprises a plurality of buoyancy modules 102A, 102B floating in water halfway submerges under the surface 106 of the water. The buoyancy modules 102A, 102B are approached by a water stream, for example wave 103. It is assumed that the water speed in the upper part 103A of the wave 103 is equal to the water speed in the lower part 103B of the wave 103, although, this is only for simplicity of the explanation and not essential.

In FIG. 1A, the buoyancy modules 102A, 102B are connected at their bottoms by a rigid frame 104. The force on the first buoyancy module 102A by the lower part 103A of the wave 103 results only a linear push action of the frame 104, whereas the force by the upper part 103B of the wave 103 induced a counter-clockwise rotational momentum 105 on the first buoyancy module 102A, which is transferred to the frame other buoyancy member 102B due to the rigid frame 104. The movement of the platform 101 in this event is complex, in that the momentum 105 of the first buoyancy module 102A will press the other buoyancy module 102B down, which, in turn, creates more buoyancy, and the reaction will cause the first buoyancy module 102A being pressed upwards. The reaction depends on how much the buoyancy modules 102A, 102B are under water, as an increase of buoyancy of the second buoyancy module 102B is only given until the buoyancy module 120B is fully submerged in the water.

In FIG. 1B, the buoyancy modules 102A, 102B are connected at midpoints by a rigid frame 104″. In this case, the upper part 103A of the wave is performing a linear push action on the frame, while the lower part 103B of the wave 103 induces a rotational momentum in the opposite, clockwise direction. Accordingly, the first buoyancy module 102A will be pressed downwards, and the other buoyancy module 102B upwards.

When having regards to offshore platforms for wind turbines, the situation is more complex, as large wave forces typically go along with wind 107, which in the simple examples of FIG. 1B induces a counter-clockwise momentum on the platform. In this view, the structure in FIG. 1B with the clockwise momentum induced by the waves has a damping effect relatively to the clockwise momentum forces by the wind on the wind turbine.

The construction of a wind turbine platform has further aspects to take into regard. One of the aspects is that the rigid frame 104, 104′ is desired to be provided to a large extent under the water surface, as it contributes with its buoyancy to the total buoyancy. On the other hand, a frame 104 that extends deeply under water is also not desired, as the assembly in the harbor gives limitations to the depth with which the platform 101 is allowed to extend.

In order to take all these aspects into account, a platform has been developed, which is presented in FIG. 3 and compared to conventional art platforms with reference to FIG. 2.

FIG. 2 illustrates a conventional art floating platform 1, where buoyancy modules 2 typically groups of buoyancy members 2′, such as buoyancy tanks, are interconnected at their lower end by connecting rods 10 to a rigid frame 4 with radial braces 13. Connecting rods 10 extend through the buoyancy members 2′ in the buoyancy modules 2 and fasten the radial braces 13 to the buoyancy modules 2. The radial braces 13 are arranged in a plane and submerged in water when the platform 1 is in use in water, for example at an offshore location. An advantage is addition of buoyancy from the submerged braces 13. However, as discussed in connection with FIG. 1A, waves 3 acting on the buoyancy modules 2 will induce a rotational momentum 5 that is added to the momentum created by the tower 8 on the platform 1 when wind 7 is acting on the rotor and the tower 8 of the wind turbine.

The floating platform 1 comprises a tower support 14 in the form of a tower support column that is supporting the tower 8 of a wind turbine wind turbine. A working platform 20 is typically attached to the tower 8.

FIG. 3 illustrates a floating platform according to embodiments of the invention in a side view. FIG. 4A shows that part of the platform, which is under the water surface 6, in a perspective view and FIG. 4B in a top view. The tower support 14 is in the center of the equilateral triangle, of which the buoyancy modules 2 are provided at the vertices of this triangle.

In comparison to the frame in FIG. 2, the frame 4 in FIGS. 3 and 4A and 4B comprise a number of differences. An important difference is the locations of the connecting rods 10 relatively to the water surface 6. As the level of the connecting rods 10 under normal conditions is at the water surface 6, the rotational momentum 5 induced by waves 3 is clockwise and partially counteracts the rotational momentum on the wind turbine by the wind 7, as already discussed in relation to FIG. 1B. Accordingly, a damping effect is achieved in relation to the inclination of the wind turbine and the platform 1 as induced by wind and waves.

The radial braces 13 are not arranged in a planar configuration, in contrast to the conventional art. Instead, the radial braces 13 are inclined with respect to the water line 6, namely by an angle β=(90°−α), where the angle α is measured between a brace centerline 16 of the radial brace 13 and the centerline 15 of the support column 14, which is also the centerline of the tower 8. Due to this inclination, the radial braces 13 are almost entirely submerged in water, although, the connection to the buoyancy modules, which is by the connecting rod 10 in at the surface of the water or potentially slightly above the waterline.

A typical value for the angle α is in the range of 80-87°, implying that the angle β=(90°−α) is in the range of 3-10°, which would be the angle between the radial brace with the water surface in calm water under non-windy conditions. In general, it can be said that the smaller α and the larger β, the more counter-momentum towards a vertical orientation of the tower is given. However, on the other hand, a smaller angle α also results in increased draft, which can be critical when mounting the wind turbine on the platform in a harbor, where often only a draft of 8 m can be accepted.

In the shown embodiment, the buoyancy member 2′ of the buoyancy module 2 has a height H, and the connecting rod 10 is located at H/2, when measured from the heave plate 9. The dimensioning of the platform 1 is made such that the platform, when carrying the wind turbine, is submerged to a depth such that the connecting rod 10 is at the level of the water surface 6. This assures that the radial braces 13 are substantially under the water surface 6 in non-windy conditions and, thus, assist in the buoyancy of the entire platform 1. The radial braces 13 are connected to the bottom part of the tower support 14.

The frame 4 of the floating platform 1 is further stabilized by comprising three lateral braces 17, each of which interconnect neighboring radial braces 13. Additionally, the frame 4 comprises three diagonal braces 19, each which extends between the top part of the support column 14 and a corresponding one of the three radial braces 13.

FIG. 5A shows that part of the floating platform 1, that is located under the water surface 6, including the buoyancy modules 2, the motion-damping heave plates 9 at the lower end of the buoyancy modules 2, as well as the radial braces 13 and the lateral braces 17. Whereas FIG. 5A illustrates the submerged part with the centerline 15 of the tower in vertical orientation, FIG. 5B shows the submerged part of the platform 1 when the centerline is inclined, for example because the wind turbine is pushed in a direction to the left by wind 7 coming from the right side. The rotational momentum induced by the wind presses the left buoyancy modules 2 deeper into the water, whereas the right buoyancy module 2 is lifted more out of the water. However, the wind 7 will also induce surface motion of the water with waves, which push onto the submerged buoyancy modules 2, which creates a counter-momentum, as explained in relation to FIG. 1B and FIG. 3. This counter-momentum has a damping effect and reduces the total momentum induced in the platform 1, which is a sum of the momentum from the tower 8 acting on the platform 1 and momentum from the waves 3 acting on the submerged part of the platform 1.

The situation in FIG. 5B is illustrated in a perspective view in FIG. 6A and in a top view in FIG. 6B.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-10. (canceled)

11. An offshore wind turbine system comprising a wind turbine in combination with a floating platform, the platform comprising a tower support that carries a tower of the wind turbine, the tower carrying a wind rotor: wherein the platform comprises three buoyancy modules providing buoyancy to the platform when in water, the three buoyancy modules being arranged in an triangular configuration in corners of an equilateral triangle, in the center of which the tower support is located: wherein the tower support includes a centerline coinciding with a centerline of the tower and being located in the center of the triangle: wherein the tower support is fixed in a frame includes three radial braces, each of the radial braces rigidly connecting the tower support with one of the three buoyancy modules: wherein each radial brace has a brace centerline, the brace centerline having an angle α with the tower support centerline; and that the radial braces are inclined upwards from the tower support towards the buoyancy modules, wherein the angle α is in the range of 80° to 87° and wherein the buoyancy modules have a height H, and wherein the radial braces are connected to the buoyancy modules at a position between 0.4 and 0.6 of the height H, wherein the buoyancy modules comprises buoyancy members such as buoyancy tanks, which are interconnected by connecting rods to the rigid frame, wherein the connecting rods extend through the buoyancy members and fasten the radial braces to the buoyancy modules, wherein the level of the connecting rods under normal conditions is at the water surface, and wherein the system in water is dimensioned for floating at a level in the water where at least 80% of the radial braces are under water for contributing to the buoyancy.

12. The system according to claim 11, wherein the frame comprises three lateral braces, each of which interconnect neighboring radial braces for additional stabilization, the three lateral braces arranged in a planar configuration perpendicular to the tower support centerline.

13. The system according to claim 12, wherein the frame comprises three diagonal braces, each of which extends from the support column and to a corresponding one of the three radial braces.

14. The system according to claim 13, wherein the three diagonal braces are connected to a top part of the tower support structure and the three radial braces are connected to a bottom part of the tower support structure.

15. The system according to claim 11, wherein the platform with the buoyancy modules and the frame when in water is dimensioned for reaching downwards into water to a depth of no more than 8 m for a wind turbine having a weight of 2,000,000 kg.

16. An offshore platform for a wind turbine that comprises a tower with a rotor; wherein the offshore platform comprises:
three buoyancy modules providing buoyancy to the platform when in water, the three buoyancy modules being arranged in an triangular configuration in corners of an equilateral triangle, in the center of which a tower support is located for carrying the tower;
wherein the tower support includes a centerline coinciding with a centerline of the tower when mounted on the platform and being located in the center of the triangle;
wherein the tower support is fixed in a frame comprising three radial braces, each of the radial braces rigidly connecting the tower support with one of the three buoyancy modules;
wherein each radial brace has a brace centerline, the brace centerline having an angle α with the tower support centerline; and the radial braces being inclined upwards from the tower support towards the buoyancy modules, wherein the angle α is in the range of 80° to 87° and wherein the buoyancy modules have a height H, and wherein the radial braces are connected to the buoyancy modules at a position between 0.4 and 0.6 of H;
wherein the buoyancy modules include buoyancy members such as buoyancy tanks, which are interconnected by connecting rods to the rigid frame, wherein the connecting rods extend through the buoyancy members and fasten the radial braces to the buoyancy modules, wherein the level of the connecting rods under normal conditions is at the water surface; and
wherein the system in water is dimensioned for floating at a level in the water where at least 80% of the radial braces are under water for contributing to the buoyancy.

17. The offshore platform according to claim 16, wherein the frame comprises three lateral braces, each of which interconnect neighboring radial braces for additional stabilization, the three lateral braces being arranged in a plane perpendicular to the tower support centerline: wherein the frame comprises three diagonal braces, each which extends from the support column and a corresponding one of the three radial braces, wherein the three diagonal braces are connected to a top part of the tower support structure and the three radial braces are connected to a bottom part of the tower support structure: wherein the tower support is a tower support column.
